(19) United States
(12) Patent Application Publication
(10) Pub. No.: US 2015/0159543 A1
(43) Pub. Date: Jun. 11, 2015

(54) ENGINE SYSTEM HAVING ALUMINUM TURBINE HOUSING

(71) Applicant: Hyundai Motor Company, Seoul (KR)

(72) Inventors: Dong Ho CHU, Ansan-si (KR); Dong Hee HAN, Seoul (KR); Hyeon Ho KIM, Yongin-si (KR); Jong Il PARK, Seoul (KR)

(73) Assignee: Hyundai Motor Company, Seoul (KR)

(21) Appl. No.: 14/470,610

(22) Filed: Aug. 27, 2014

(30) Foreign Application Priority Data
Dec. 6, 2013 (KR) 10-2013-0151785

(51) Int. Cl. F02B 29/04; F02B 37/18; F01P 3/02

(52) U.S. Cl. CPC F02B 29/0475; F01P 3/02; F02B 37/183

(57) ABSTRACT

An engine system may include an intake route control valve installed on a first intake line supplying outdoor air to an intake manifold; a second intake line bypassing the first intake route control valve; an exhaust route control valve installed on a first exhaust line on which exhaust gas discharged from an exhaust manifold flows; a turbo charger which includes: a turbine actuated by exhaust gas passing through a second exhaust line that bypasses the exhaust route control valve; and a compressor pumping intake air that flows on the second intake line; a turbine housing which is mounted with the turbine and made of an aluminum alloy; an electric water pump which pumps cooling water circulated in the turbine housing; and a controller which controls the intake route control valve, the exhaust route control valve, and the electric water pump according to an operation condition.

### CROSS-REFERENCE TO RELATED APPLICATION

The present application claims priority to and the benefit of Korean Patent Application No. 10-2013-0151785 filed on Dec. 6, 2013, the entire contents of which is incorporated herein for all purposes by this reference.

### BACKGROUND OF THE INVENTION

1. Field of the Invention

The present invention relates to an engine system having an aluminum turbine housing that improves an output in a low-speed range and increases combustion efficiency by using a turbo charger, and improves the quality of exhaust gas.

2. Description of Related Art

In general, it is known that a diesel engine has lower consumption of fuel and higher fuel efficiency than a gasoline engine. The diesel engine generally has efficiently of approximately 40%, which is based on a high compression ratio of the diesel engine.

In recent years, an engine further includes a turbo charger and an intercooler so as to acquire a higher output.

As described above, the engine including the turbo charger takes in and compresses exhaust gas or external air by a compressor of the turbo charger and supplies supercharged air (high-temperature compressed air) generated at that time to an engine side.

However, rapidly compressed air absorbs heat of the turbo charger and heat generated during the compression and the density of the air is decreased, and as a result, charging efficiency in an engine combustion chamber deteriorates. Therefore, the supercharged air is cooled by using the intercooler to acquire high density, and as a result, more air is taken in by the engine combustion chamber to acquire the higher output.

Meanwhile, a research for decreasing fuel consumption and increasing output torque in a middle-low speed range of an engine RPM in the engine including the turbo charger is in progress and a research into making a turbine housing of aluminum and cooling the turbine housing is also in progress.

The information disclosed in this Background of the Invention section is only for enhancement of understanding of the general background of the invention and should not be taken as an acknowledgement or any form of suggestion that this information forms the prior art already known to a person skilled in the art. CL BRIEF SUMMARY

Various aspects of the present invention are directed to providing an engine system that decreases fuel consumption and increases output torque in a predetermined middle-low speed range in which an engine rpm is present and effectively cools an aluminum turbine housing in an engine having a turbo charger.

In an aspect of the present invention, an engine system having a turbine housing, may include an intake route control valve which is installed on a first intake line that supplies outdoor air to an intake manifold attached to a cylinder block, a second intake line which bypasses the first intake route control valve, an exhaust route control valve which is installed on a first exhaust line on which exhaust gas discharged from an exhaust manifold attached to the cylinder block flows, a turbo charger which may include a turbine actuated by exhaust gas passing through a second exhaust line that bypasses the exhaust route control valve, and a compressor pumping intake air that flows on the second intake line, the turbine housing which is mounted with the turbine and made of an aluminum alloy, an electric water pump which pumps cooling water circulated in the turbine housing, and a controller which controls the intake route control valve, the exhaust route control valve, and the electric water pump according to an operation condition.

While the cooling water is circulated in the intercooler, the turbine housing, and the exhaust route control valve, the cooling water cools the intercooler, the turbine housing, and the exhaust route control valve.

The controller circulates the cooling water to the turbine housing for a predetermined time after turning off an engine.

The controller does not circulate the cooling water to the turbine housing for a predetermined time after turning on the engine.

The turbine housing is integrally formed in the exhaust manifold of the cylinder block and is coupled separately from the exhaust manifold of the cylinder block.

The exhaust manifold is integrally formed in the cylinder block or coupled separately from the cylinder block.

A cooling line circulated in the cylinder block and a cooling line circulated in the turbine housing are separated from each other and a cooling line of a radiator is separated.

The system may further include a shaft which connects the turbine and the compressor in the turbo charger, and a bearing housing which rotatably supports the shaft, wherein the cooling water is circulated in the turbine housing and the bearing housing.

According to the exemplary embodiment of the present invention, torque is increased in a low-speed range by additionally injecting air by using a turbo charger at an rpm or less (low-speed range) set in the existing natural air intake type gasoline engine to improve fuel efficiency.

Since the turbo charger is used at the set engine rpm, a turbine housing can be made of aluminum and the turbine housing is cooled by making cooling water flow on the turbine housing, thereby decreasing total production cost and a total weight of the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic configuration diagram of an engine system having an aluminum turbine housing according to an exemplary embodiment of the present invention.

FIG. 2 is a partial schematic configuration diagram of an engine system having an aluminum turbine housing according to an exemplary embodiment of the present invention.

FIG. 3 is a flowchart illustrating the flow of cooling water in an engine system having an aluminum turbine housing according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

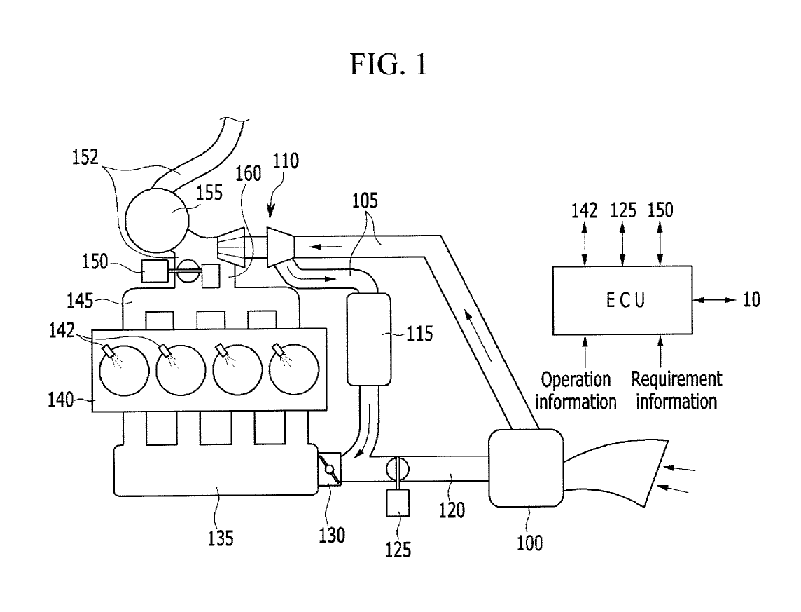

FIG. 1 is a schematic configuration diagram of an engine system having an aluminum turbine housing according to an exemplary embodiment of the present invention.

Referring to FIG. 1, the engine system includes an air cleaner box 100, a first intake line 120, a second intake line 105, a throttle body 130, an intake manifold 135, a cylinder block 140, an injector 142, an exhaust manifold 145, a first exhaust line 152, an exhaust route control valve 150, a catalyst 155, an intercooler 115, a second exhaust line 160, a turbo charger 110, and a controller (ECU) 10.

The second suction line 105 bypasses an intake route control valve 125, and is branched at the air cleaner box 100 and joins the first intake line 120 through a compressor and the intercooler 115 of the turbo charger 110.

The throttle body 130 is disposed at a point where the first intake line 120 and the second intake line 105 join. Herein, the second intake line 105 is not branched at the air cleaner box 100 but may be branched at the first intake line 120.

The first exhaust line 152 is branched at the exhaust manifold 145 and the exhaust route control valve 150 and the catalyst 155 are sequentially disposed on the first exhaust line 152.

The second exhaust line 160 bypasses the exhaust route control valve 150, and the second exhaust line 160 is branched at the exhaust manifold 145 to join the first exhaust line 152 between the exhaust route control valve 150 and the catalyst 155. Herein, the second exhaust line 160 is not branched at the exhaust manifold 145, but may be branched at the first exhaust line 152.

In the exemplary embodiment of the present invention, while the controller 10 closes the intake route control valve 125, intake air is supplied from the second intake line 105 to the intake manifold 135 through the compressor and the intercooler 115 of the turbo charger 110.

Moreover, while the controller 10 opens the intake route control valve 125, the intake air is supplied to a combustion chamber of the cylinder block 140 through the first intake line 120 and the throttle body 130.

When the controller 10 fully opens the exhaust route control valve 150, exhaust gas is discharged to the outside through the catalyst of the first exhaust line 152 and when the exhaust route control valve 150 is closed, the exhaust gas actuates a turbine of the turbo charger through the second exhaust line 160 and is discharged to the outside through the catalyst 155.

The controller 10 may control the actuation of the turbo charger 110 by controlling an opening degree of the exhaust route control valve 150, calculate required torque by sensing an operation condition of an engine and requirements of a driver such as an acceleration sensor and a brake sensor, and inject fuel by controlling the exhaust route control valve 150 and the injector 142.

In the exemplary embodiment of the present invention, air is additionally supplied by using the turbo charger 110 in a low-speed range which is equal to or less than a predetermined value to increase torque at a low speed in the existing natural intake type gasoline engine and the performance of the natural intake type may be maintained without a help from the turbo charger 110 in a high-speed range which is equal to or more than the predetermined value.

Moreover, a capacity of the turbo charger 110 is characterized in that an air flow coefficient is equal to or less than 2 based on an air flow that passes through the compressor and herein, the air flow coefficient=maximum air flow passing through the compressor (kg/h)/exhaust amount (L).

In addition, supercharging by the turbo charger 110 may be performed only at a set engine rpm or less, at which maximum torque is generated in a natural intake type engine. Therefore, at the set engine rpm or more, the intake route control valve 125 and the exhaust route control valve 150 are fully opened to show similar or the same performance as the natural intake type engine.

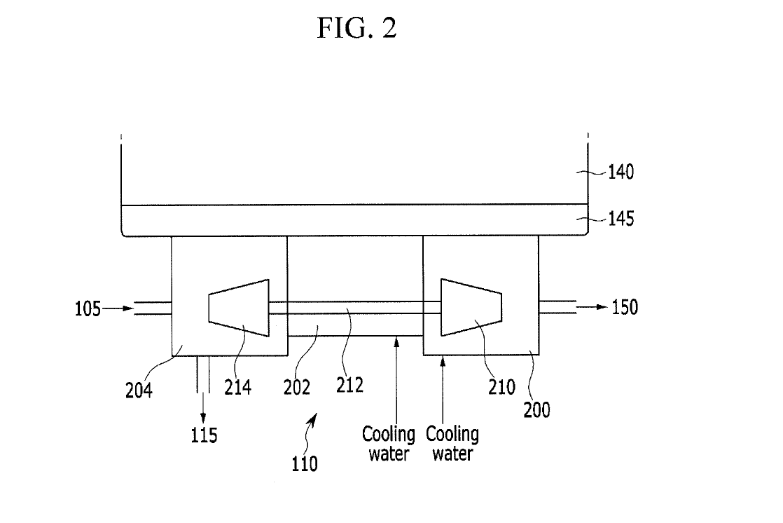

FIG. 2 is a partial schematic configuration diagram of an engine system having an aluminum turbine housing according to an exemplary embodiment of the present invention.

Referring to FIG. 2, the exhaust manifold 145 is integrally formed in the cylinder block 140 and the turbo charger 110 includes an aluminum turbine housing 200, a bearing housing 202, and a compressor housing 204.

The turbine 210 is disposed in the turbine housing 200, a bearing and a shaft 212 are disposed in the bearing housing 202, and the compressor 214 is disposed in the compressor housing 204.

The aluminum turbine housing 200 is integrally formed in the exhaust manifold 145 or the cylinder block 140, and is made of an aluminum alloy and has a cooling water path or a chamber therein.

There is provided a structure that the exhaust gas discharged from the exhaust manifold 145 is supplied to the turbine housing 200 and high-temperature and high-pressure exhaust gas rotate the turbine 210, and the turbine housing 200 needs to be cooled.

In exemplary embodiment of the present invention, the controller 10 increases cooling efficiency by controlling the cooling water supplied to the aluminum turbine housing 200 and decrease LOT of the catalyst.

Moreover, the cooling water that cools the aluminum turbine housing 200 may be circulated in a cooling water line separated from cooling water that is circulated in the cylinder block 140.

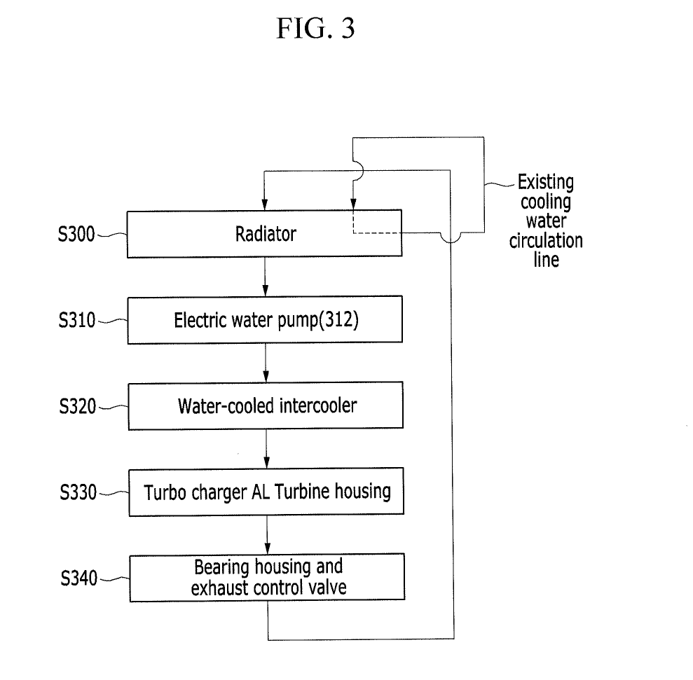

FIG. 3 is a flowchart illustrating the flow of cooling water in an engine system having an aluminum turbine housing according to an exemplary embodiment of the present invention.

Referring to FIG. 3, the existing cooling water circulation line that cools the cylinder block 140 is formed and known technology is seen for the existing cooling water circulation line and a detailed description thereof will be skipped.

In S300, the cooling water dissipates heat while passing through a radiator and in S310, the cooling water is pumped by an electric water pump 312. In S320, the cooling water may cool intake compressed air while passing through a water-cooled intercooler 115.

In S330, the cooling water may cool the aluminum turbine housing 200 of the turbo charger 110 and in S340, the cooling water may cool the bearing housing 202 and the exhaust route control valve 150.

When the turbine housing 200 is manufactured by cast steel material, manufacturing cost is increased and a weight may be increased. Accordingly, the turbine housing 200 is manufactured by the aluminum alloy to decrease both the manufacturing cost and the weight.

However, the turbine housing 200 needs to be cooled by the cooling water so that the turbine housing 200 made of the aluminum material withstands a high temperature

Particularly, when the engine is stopped while being actuated and is continuously in an idle state, the temperature of the turbine housing 200 is rapidly increased, and as a result, the turbine housing 200 needs to be cooled. Moreover, a capacity of the radiator needs to be increased in the case of cooling both a cylinder head and the turbine housing 200.

Therefore, in the exemplary embodiment of the present invention, the turbine housing 200 is cooled by using cooling water that flows on a separate cooling water line. Particularly, the turbine housing 200 may be added to the cooling line that cools the intercooler 115.

Moreover, a radiator that cools the cooling water circulated in the turbine housing 200 and the intercooler 115 may be separately provided and the capacity of the existing radiator for the intercooler may be increased, and the cooling water may be separated and circulated.

Further, the electric water pump 312 is adopted so that the cooling water selectively cools the turbine housing 200, the intercooler 115, and the exhaust route control valve 150. Known technology is seen for a structure and a control method of the electric water pump and a detailed description thereof will be skipped.

Moreover, hot cooling water discharged from the turbine housing 200, the bearing housing 202, or the exhaust route control valve 150 may be supplied directly to the radiator. In addition, cold cooling water discharged from the radiator may be supplied to the intercooler 115.

In the exemplary embodiment of the present invention, the controller 10 controls the cooling water that is circulated in the intercooler 115, the turbine housing 200, the bearing housing 202, and the exhaust route control valve 150 by controlling the electric water pump 312.

Particularly, when the engine is turned off while being actuated, the cooling water is made to flow to the turbine housing 200 for a predetermined time to improve durability of the aluminum turbine housing 200. Further, the cooling water circulated in the turbine housing 200 may be circulated in the cylinder head of the engine.

In the exemplary embodiment of the present invention, the cooling water circulated in the cylinder block 140 and the cooling water circulated in the head and the turbine housing 200 are separated from each other, and even the radiator may be separated.

In addition, the cooling water is not supplied to the cylinder head and the turbine housing 200 for a predetermined time after the engine is started to decrease the LOT of the catalyst and shorten an warm-up time of the engine.

Moreover, the turbine housing 200 and the bearing housing 202 are also integrally formed, and since the cooling water is circulated in the turbine housing 200 and the bearing housing 202, cooling water that flows on a separate cooling water line effectively cools the turbine housing 200 even under a high-temperature operation condition.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. An engine system having a turbine housing, the system comprising:
an intake route control valve which is installed on a first intake line that supplies outdoor air to an intake manifold attached to a cylinder block;
a second intake line which bypasses the first intake route control valve;
an exhaust route control valve which is installed on a first exhaust line on which exhaust gas discharged from an exhaust manifold attached to the cylinder block flows;
a turbo charger which includes:
a turbine actuated by exhaust gas passing through a second exhaust line that bypasses the exhaust route control valve; and
a compressor pumping intake air that flows on the second intake line;
the turbine housing which is mounted with the turbine and made of an aluminum alloy;
an electric water pump which pumps cooling water circulated in the turbine housing; and
a controller which controls the intake route control valve, the exhaust route control valve, and the electric water pump according to an operation condition.

2. The system of claim 1, wherein while the cooling water is circulated in the intercooler, the turbine housing, and the exhaust route control valve, the cooling water cools the intercooler, the turbine housing, and the exhaust route control valve.

3. The system of claim 1, wherein the controller circulates the cooling water to the turbine housing for a predetermined time after turning off an engine.

4. The system of claim 1, wherein the controller does not circulate the cooling water to the turbine housing for a predetermined time after turning on the engine.

5. The system of claim 1, wherein the turbine housing is integrally formed in the exhaust manifold of the cylinder block and is coupled separately from the exhaust manifold of the cylinder block.

6. The system of claim 5, wherein the exhaust manifold is integrally formed in the cylinder block or coupled separately from the cylinder block.

7. The system of claim 1, wherein a cooling line circulated in the cylinder block and a cooling line circulated in the turbine housing are separated from each other and a cooling line of a radiator is separated.

8. The system of claim 1, further comprising:
a shaft which connects the turbine and the compressor in the turbo charger; and
a bearing housing which rotatably supports the shaft,
wherein the cooling water is circulated in the turbine housing and the bearing housing.
